(19) United States
(12) Patent Application Publication
(10) Pub. No.: US 2026/0005720 A1
(43) Pub. Date: Jan. 1, 2026

(54) COMMUNICATION CONTROL SYSTEM, COMMUNICATION CONTROL METHOD, AND COMPUTER READABLE STORAGE MEDIUM

(71) Applicant: HONDA MOTOR CO.,LTD., Tokyo (JP)

(72) Inventor: Kosei TSUSHIMA, Tokyo (JP)

(21) Appl. No.: 19/239,831

(22) Filed: Jun. 16, 2025

(30) Foreign Application Priority Data
Jun. 28, 2024 (JP) 2024-105083

(51) Int. Cl. H04B 1/401; H04B 7/026; H04B 7/15; H04W 88/04

(52) U.S. Cl. CPC H04B 1/401; H04B 7/026; H04B 7/15; H04W 88/04

(57) ABSTRACT

A communication control system controls communication in a communication terminal which relays communication between a movable body and an information management device. The communication control system includes a selection unit which selects, according to a state of communication between the communication terminal and the information management device, a relay mode in which the communication terminal relays the communication between the movable body and the information management device. A communication control method includes selecting, according to a state of communication between the communication terminal and the information management device, a relay mode in which the communication terminal relays the communication between the movable body and the information management device.

The contents of the following patent application(s) are incorporated herein by reference:
NO. 2024-105083 filed in JP on Jun. 28, 2024.

### BACKGROUND

### 1. Technical Field

The present invention relates to a communication control system, a communication control method, and a computer readable storage medium.

### 2. Related Art

Patent document 1 describes a technique with which, when data is to be transmitted to another communication device via a relay device, it becomes possible to perform data transmission according to a relay function of data in the relay device. Patent documents 2 to 5 describe a technique related to an access point.

### PRIOR ART DOCUMENTS

### Patent Documents

Patent Document 1: Japanese Patent Application Publication No. 2012-4990
Patent Document 2: International Publication No. 2012/046391
Patent Document 3: Japanese Patent Application Publication No. 2005-323357
Patent Document 4: Japanese Translation Publication of a PCT Route Patent Application No. 2016-511600.
Patent Document 5: Japanese Translation Publication of a PCT Route Patent Application No. 2009-503991.

### BRIEF DESCRIPTION OF THE DRAWINGS

FIG. 1 schematically illustrates a utilization form of a communication system 5 in an embodiment.

FIG. 2 schematically illustrates an example of a system configuration included in a communication terminal 100.

FIG. 3 schematically illustrates an example of a system configuration included in an information management device 130.

FIG. 4 schematically illustrates an example of a system configuration included in a communication management device 140.

FIG. 5 illustrates an example of a sequence according to a communication control method performed in a communication system 5.

FIG. 6 illustrates an example of a flowchart according to the communication control method performed by the communication terminal 100.

FIG. 7 illustrates an example of a computer 2000.

### DESCRIPTION OF EXEMPLARY EMBODIMENTS

Hereinafter, the present invention will be described by way of embodiments of the invention. However, the following embodiments are not for limiting the invention according to the claims. In addition, not all of the combinations of features described in the embodiments are essential to the solution of the invention.

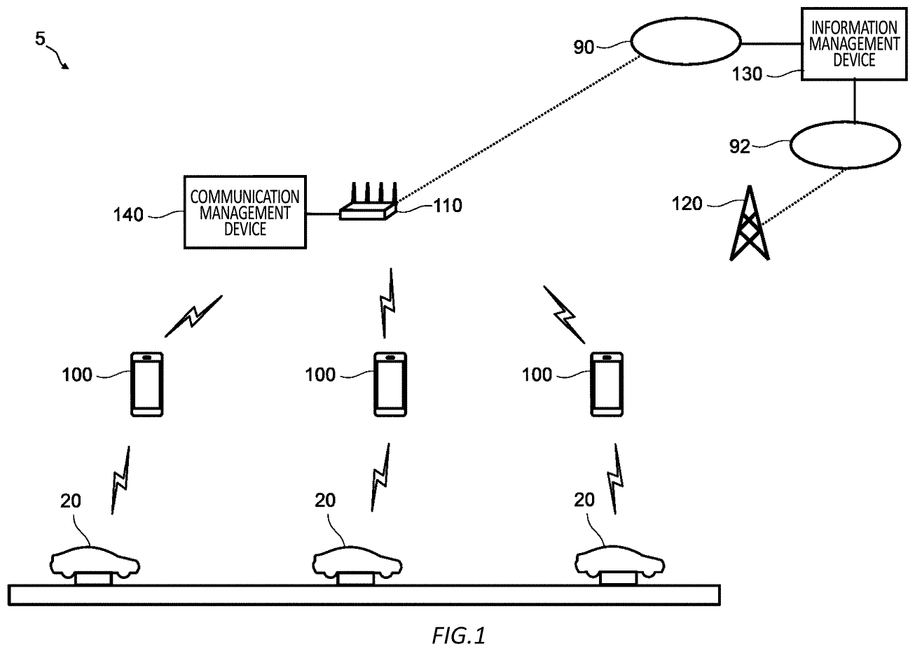

FIG. 1 schematically illustrates a configuration of a communication system 5 according to an embodiment. The communication system 5 includes a plurality of communication terminals 100, a wireless relay device 110, an information management device 130, a communication management device 140, a plurality of movable bodies 20, and a wireless base station 120.

The movable body 20 is movable equipment. The movable body 20 is, for example, a vehicle such as an automobile such as a bus or a train. The vehicle is an example of transportation equipment. The movable body 20 may be various aircrafts or the like including an unmanned air vehicle. In the present embodiment, the movable body 20 is a vehicle. In the present embodiment, the movable body 20 is a vehicle being manufactured in a factory. For example, the movable body 20 is a vehicle being manufactured which is transported in a production line. The movable body 20 has at least a wireless communication function. The movable body 20 has, for example, a wireless LAN communication function.

The information management device 130 is, for example, provided outside the factory in which the movable body 20 is manufactured. The information management device 130 holds information to be provided to the movable body 20. The information management device 130 further holds information transmitted from the movable body 20.

The wireless base station 120 is a cellular communication base station supporting one or more cellular communication schemes. The cellular communication schemes supported by the wireless base station 120 may be, for example, communication schemes used in mobile communication systems such as a fourth generation mobile communication system (4G) and a fifth generation mobile communication system (5G). The wireless base station 120 can communicate with the information management device 130 through a cellular communication network 92.

The wireless relay device 110 has a function of relaying wireless LAN communication. The wireless relay device 110 can communicate with the information management device 130 through a communication network 90 such as the Internet.

The communication terminal 100 is a terminal which has a communication function. The communication terminal 100 is, for example, a mobile terminal such as a smartphone. The communication terminal 100 may be a communication terminal preinstalled in a factory. The communication terminal 100 may be a mobile terminal possessed by an operator in the factory. The communication terminal 100 has a wireless communication function. For example, the communication terminal 100 has a cellular communication function and a wireless LAN communication function. The communication terminal 100 has a wireless LAN access point function and relays communication between the movable body 20 and the information management device 130 through the wireless base station 120.

The communication terminal 100 may function as a wireless LAN access point for the movable body 20 and simultaneously function as a station for the wireless relay device 110. The communication terminal 100 relays the communication between the movable body 20 and the information management device 130 through the wireless relay device 110 and the communication network 90. With this configuration, when being on the production line, the movable body 20 can establish wireless communication with the communication terminal 100 near a current position of the movable body 20 to communicate with the information management device 130 through the wireless relay device 110 or the wireless base station 120 and exchange information with the information management device 130.

The communication management device 140 performs processing to manage the communication between the movable body 20 and the information management device 130. For example, the communication management device 140 registers various information required for the movable body 20 and the communication terminal 100 to perform communication. The communication management device 140 manages a wireless access point function provided by the communication terminal 100.

The communication terminal 100 has a first mode, a second mode, and a third mode as relay modes in which the communication between the movable body 20 and the information management device 130 is to be relayed. The first mode is a mode in which data to be communicated between the movable body 20 and the information management device 130 is transferred from one to another. The second mode is a mode in which data to be communicated between the movable body 20 and the information management device 130 is temporarily held, transfer of the temporarily held data is started according to a state of communication between the communication terminal 100 and the information management device 130, and also relay of the communication between the movable body 20 and the information management device 130 is resumed. The third mode is a mode in which data to be communicated between the movable body 20 and the information management device 130 is held, and transfer of the held data is started in response to acceptance of a data transfer instruction.

The communication terminal 100 relays the communication between the movable body 20 and the information management device 130 in one mode among the first mode, the second mode, and the third mode according to a state of communication between the communication terminal 100 and the information management device 130. For example, according to a situation where the state of the communication between the communication terminal 100 and the information management device 130 has deteriorated while the communication is relayed in the first mode, the communication terminal 100 switches the communication to be relayed in the second mode. When a security level of the communication between the communication terminal 100 and the information management device 130 is low, the communication terminal 100 relays the communication in the third mode. With this configuration, the relay can be performed in an appropriate mode according to the state of the communication between the communication terminal 100 and the information management device 130.

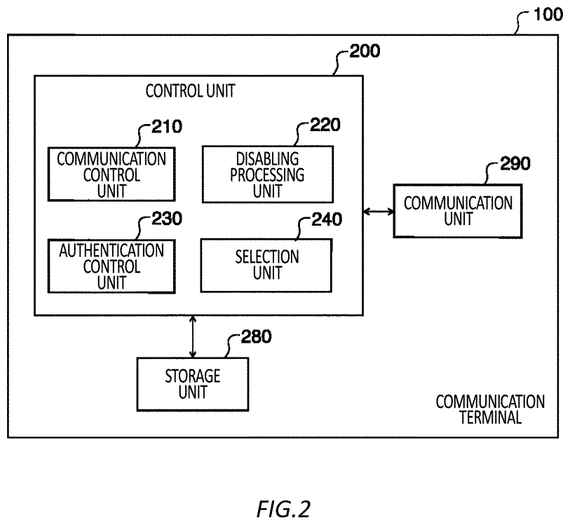

FIG. 2 schematically illustrates an example of a system configuration included in the communication terminal 100. The communication terminal 100 includes a control unit 200, a storage unit 280, and a communication unit 290. The control unit 200 includes a communication control unit 210, a disabling processing unit 220, an authentication control unit 230, and a selection unit 240.

The control unit 200 controls the entire communication terminal 100. The control unit 200 may be an example of a communication control system and may be a part of the communication control system. The communication unit 290 is responsible for wireless communication between each of the movable body 20, the wireless relay device 110, and the wireless base station 120 and the communication terminal 100. The control unit 200 is realized by an arithmetic processing device including a processor. The storage unit 280 is realized by including a nonvolatile storage medium. The control unit 200 performs processing by using information stored in the storage unit 280. The control unit 200 may be realized by a computer including a CPU, a ROM, a RAM, an I/O, a bus, and the like. The communication terminal 100 may be realized by a single computer.

The control unit 200 functions as a communication control system which controls communication in the communication terminal 100 which relays the communication between the movable body 20 and the information management device 130. The selection unit 240 selects, according to a state of communication between the communication terminal 100 and the information management device 130, a relay mode in which the communication between the movable body 20 and the information management device 130 is relayed by the communication terminal 100. In the movable body 20 that is being manufactured, the cellular communication may be restricted, but according to the present embodiment, transmission and reception of data with the information management device 130 which is required during manufacturing of the movable body 20 can be performed via the communication terminal 100. With this configuration, communication costs can be reduced. In addition to the above, since the selection unit 240 selects the relay mode according to the state of the communication, the communication can be relayed in an appropriate mode according to the relay mode.

The relay modes may include at least one of the first mode in which the data to be communicated between the movable body 20 and the information management device 130 is transferred from one to another, the second mode in which the data to be communicated between the movable body 20 and the information management device 130 is temporarily held in a storage medium included in the communication terminal 100, and transfer of the data temporarily held in the storage medium is started according to a state of communication between the communication terminal 100 and the information management device 130 and also relay of the communication between the movable body 20 and the information management device 130 is resumed, or the third mode in which the data to be communicated between the movable body 20 and the information management device 130 is held in the storage medium, and transfer of the data held in the storage medium is started in response to acceptance of the data transfer instruction. With this configuration, according to the state of the communication, it is possible to select whether the relay is performed in the mode in which the data is immediately transferred, the relay is performed in the mode in which the data to be communicated is temporarily held in the communication terminal 100, or the relay is performed in the mode in which the data may be held for a long period of time. Therefore, the relay mode can be flexibly changed according to the state of the communication, and the data from the movable body 20 can be continuously collected. The storage medium which holds the data in the second mode and the third mode may be a nonvolatile storage medium.

The selection unit 240 may select the relay mode further based on a state of the storage medium included in the communication terminal 100. For example, the selection unit 240 may select the first mode when at least one of a capacity of the storage medium included in the communication terminal 100 or an amount of available space of the storage medium is less than or equal to a predetermined value. With this configuration, when a memory space of the storage medium included in the communication terminal 100 is insufficient, the communication can be relayed in the first mode in which the memory space is not consumed as much as the second mode and the third mode.

The selection unit 240 selects the relay mode based on a state of communication between the communication terminal 100 and the wireless relay device 110 which relays the communication between the communication terminal 100 and the information management device 130. For example, the selection unit 240 may select the first mode when a quality of the communication between the wireless relay device 110 and the communication terminal 100 is greater than or equal to a predetermined value. With this configuration, since the first mode can be selected when the quality of the communication is relatively high, transmission of the communication to the information management device 130 can be kept. The selection unit 240 may select the second mode when the quality of the communication between the wireless relay device 110 and the communication terminal 100 is less than the predetermined value. With this configuration, by selecting the second mode when the quality of the communication is low, the collection of the data from the movable body 20 can continue, and when the quality of the communication recovers, the data held in the communication terminal 100 can be transmitted to the information management device 130.

The selection unit 240 may select the relay mode in which the communication between the movable body 20 and the information management device 130 is relayed by the communication terminal 100 according to a security level of the communication between the communication terminal 100 and the information management device 130. The selection unit 240 may select the third mode when the security level is less than or equal to a predetermined value. With this configuration, when the security level of the communication is less than or equal to a required level, by selecting the third mode, a security risk such as data leak can be reduced. With this configuration, when transmission to the information management device 130 through the communication network 90 including the Internet via the wireless relay device 110 is not desirably for a security reason, by selecting the third mode, the security risk such as data leak can be reduced. In addition, the selection unit 240 may select the third mode in response to an instruction from a user such as an operator. For example, when data required to be checked immediately on the communication terminal 100 is to be collected from the movable body 20, the user may instruct the communication terminal 100 to select the third mode.

When the communication terminal 100 can communicate with the information management device 130 based on the cellular communication and the wireless LAN communication, the communication control unit 210 may cause the communication terminal 100 to communicate with the information management device 130 based on the wireless LAN communication by priority over the cellular communication. With this configuration, since a use frequency of the cellular communication can be lowered, the communication costs can be reduced.

The plurality of communication terminals 100 and the movable body 20 may be capable of establishing wireless LAN connection through a single SSID. For example, the communication terminal 100 and the movable body 20 may be equipment supporting OpenRoaming. The communication control unit 210 may set an SSID common to the plurality of communication terminals 100 to enable the movable body 20 to establish wireless LAN connection with the plurality of communication terminals 100 through the single SSID. When the connection can be established through the common SSID, the wireless LAN connection can be seamlessly established over the plurality of communication terminals 100. When a setting such as OpenRoaming is configured in the movable body 20 and the communication terminal 100, since connection can be automatically established with a corresponding wireless LAN network, cumbersome reconnection processing can be avoided even when the movable body 20 moves to connect to another communication terminal 100.

The authentication control unit 230 may perform authentication between the movable body 20 and the communication terminal 100 by 802.11u based authentication and mutual authentication between the movable body 20 and the communication terminal 100. With this configuration, the security risk can be reduced.

The disabling processing unit 220 disables the function of the communication terminal 100 to relay the communication between the movable body 20 and the information management device 130 when a duration of a period in which the communication terminal 100 does not relay the communication between the movable body 20 and the information management device 130 is longer than a predetermined value. With this configuration, a state of being stay-connected with the network over a long period of time by the communication terminal 100 which is not used for the relay can be suppressed. Therefore, the security risk can be reduced.

After the relay function of the communication in the communication terminal 100 has been disabled by the disabling processing unit 220, the communication terminal 100 may enable the relay function of the communication based on an instruction from the information management device 130. For example, when the communication terminal 100 receives an instruction of enabling the relay function from the information management device 130 through the wireless relay device 110 and/or the wireless base station 120, the relay function of the communication in the communication terminal 100 may be enabled again.

Even when the communication terminal 100 can communicate with the information management device 130 based on the cellular communication, the communication control unit 210 may restrict the communication between the communication terminal 100 and the information management device 130 based on the cellular communication. Under a condition that high security level communication is required, the communication control unit 210 may allow the communication based on the cellular communication. The communication control unit 210 may allow the communication based on the cellular communication when another communication means does not exist. The communication control unit 210 may allow the communication based on the cellular communication only at night. In this manner, by restricting the communication based on the cellular communication, the communication costs can be reduced.

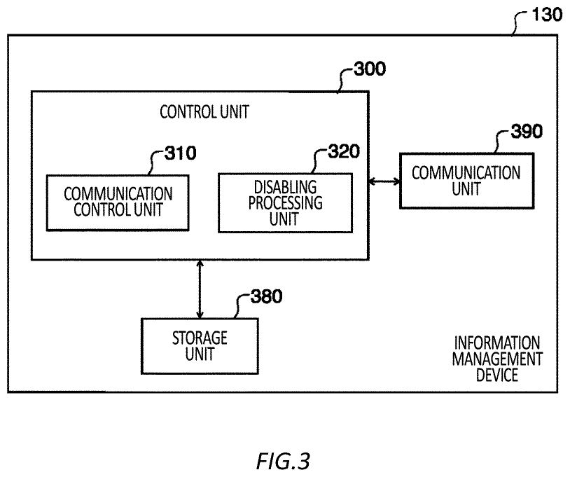

FIG. 3 schematically illustrates an example of a system configuration included in the information management device 130. The information management device 130 includes a control unit 300, a storage unit 380, and a communication unit 390. The control unit 300 includes a communication control unit 310 and a disabling processing unit 320.

The control unit 200 controls the entire information management device 130. The control unit 300 may be an example of a communication control system or may be a part of the communication control system. The communication unit 390 is responsible for wireless communication between each of the wireless relay device 110 and the wireless base station 120 and the information management device 130. The control unit 300 is realized by an arithmetic processing device including a processor. The storage unit 380 is realized by including a nonvolatile storage medium. The control unit 300 performs processing by using information stored in the storage unit 380. The control unit 300 may be realized by a computer including a CPU, a ROM, a RAM, an I/O, a bus, and the like. The information management device 130 may be realized by a single computer. The information management device 130 may be realized by a plurality of computers. A function of the information management device 130 may be realized by a virtual system realized by using a virtualization technique.

The communication control unit 310 performs processing corresponding to the communication control unit 210. When the communication terminal 100 can communicate with the information management device 130 based on the cellular communication and the wireless LAN communication, the communication control unit 310 may cause the communication terminal 100 to communicate with the information management device 130 based on the cellular communication by priority over the wireless LAN communication. Even when the communication terminal 100 can communicate with the information management device 130 based on the cellular communication, the communication control unit 310 may restrict the communication between the communication terminal 100 and the information management device 130 based on the cellular communication. The communication control unit 310 may set an SSID common to the plurality of communication terminals 100 to enable the movable body 20 to establish wireless LAN connection with the plurality of communication terminals 100 through a single SSID. For example, the communication control unit 310 may perform processing to configure the communication terminal 100 according to a specification of OpenRoaming such that the communication terminal 100 can communicate according to the specification of OpenRoaming.

The disabling processing unit 320 performs processing corresponding to the disabling processing unit 220. The disabling processing unit 320 disables the function of the communication terminal 100 to relay the communication between the movable body 20 and the information management device 130 when the duration of the period in which the communication terminal 100 does not relay the communication between the movable body 20 and the information management device 130 is longer than a predetermined value. For example, the disabling processing unit 320 may instruct the communication terminal 100 such that the communication terminal 100 stops functioning as the wireless LAN access point. By measuring an elapsed time from a moment in time at which the data transmitted from the movable body 20 via the communication terminal 100 has been last received, the disabling processing unit 320 may measure the duration of the period in which the communication terminal 100 does not relay the communication between the movable body 20 and the information management device 130.

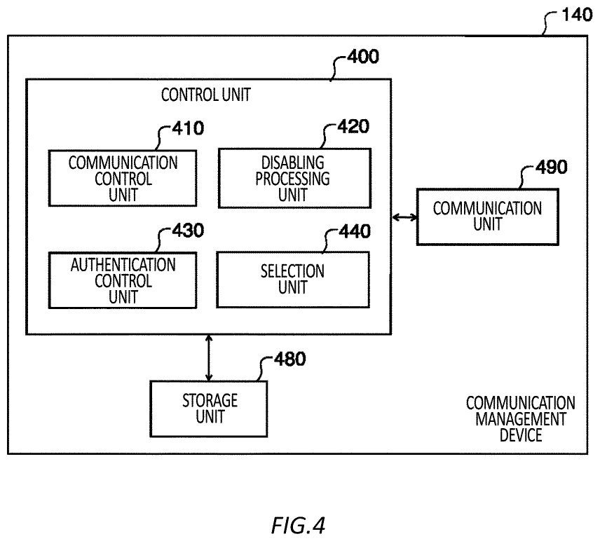

FIG. 4 schematically illustrates an example of a system configuration included in the communication management device 140. The communication management device 140 includes a control unit 400, a storage unit 480, and a communication unit 490. The control unit 400 includes a communication control unit 410, a disabling processing unit 420, an authentication control unit 430, and a selection unit 440.

The control unit 400 controls the entire communication management device 140. The control unit 400 may be an example of a communication control system or may be a part of the communication control system. The communication unit 490 is responsible for wireless communication between the wireless relay device 110 and the communication management device 140. The control unit 400 is realized by an arithmetic processing device including a processor. The storage unit 480 is realized by including a nonvolatile storage medium. The control unit 400 performs processing by using information stored in the storage unit 480. The control unit 400 may be realized by a computer including a CPU, a ROM, a RAM, an I/O, a bus, and the like. The communication management device 140 may be realized by a single computer. The communication management device 140 may be realized by a plurality of computers. A function of the communication management device 140 may be realized by a virtual system realized by using a virtualization technique.

The communication control unit 410 performs processing corresponding to the communication control unit 210. When the communication terminal 100 can communicate with the information management device 130 based on the cellular communication and the wireless LAN communication, the communication control unit 410 may cause the communication terminal 100 to communicate with the information management device 130 based on the cellular communication by priority over the wireless LAN communication. Even when the communication terminal 100 can communicate with the information management device 130 based on the cellular communication, the communication control unit 410 may restrict the communication between the communication terminal 100 and the information management device 130 based on the cellular communication. The communication control unit 410 may set an SSID common to the plurality of communication terminals 100 to enable the movable body 20 to establish wireless LAN connection with the plurality of communication terminals 100 through a single SSID. For example, the communication control unit 410 may perform processing to configure the communication terminal 100 according to the specification of OpenRoaming such that the communication terminal 100 can communicate according to the specification of OpenRoaming.

The disabling processing unit 420 performs processing corresponding to the disabling processing unit 220. The disabling processing unit 420 disables the function of the communication terminal 100 to relay the communication between the movable body 20 and the information management device 130 when the duration of the period in which the communication terminal 100 does not relay the communication between the movable body 20 and the information management device 130 is longer than a predetermined value. For example, the disabling processing unit 420 may instruct the communication terminal 100 such that the communication terminal 100 stops functioning as the wireless LAN access point. By measuring an elapsed time from a moment in time at which the communication terminal 100 has last transmitted, to the information management device 130, the data transmitted from the movable body 20, the disabling processing unit 420 may measure the duration of the period in which the communication terminal 100 does not relay the communication between the movable body 20 and the information management device 130. By acquiring a transmission history in the communication terminal 100 or the wireless relay device 110, the disabling processing unit 420 may measure the duration of the period in which the communication terminal 100 does not relay the communication between the movable body 20 and the information management device 130.

The authentication control unit 430 performs control to transmit authentication information required for the communication terminal 100 to perform authentication with the movable body 20. A selection unit 440 performs processing corresponding to the selection unit 240. The selection unit 440 performs processing to select a relay mode in which the communication terminal 100 relays the communication between the movable body 20 and the information management device 130 according to a state of communication between the communication terminal 100 and the information management device 130. The communication management device 140 acquires, from the communication terminal 100, information indicating the state of the communication between the communication terminal 100 and the information management device 130, and the selection unit 440 performs processing to select the relay mode based on the acquired information. The communication management device 140 may transmit information indicating the relay mode selected by the selection unit 440 to the communication terminal 100 and instruct the communication terminal 100 to relay the communication between the movable body 20 and the information management device 130 in the relay mode.

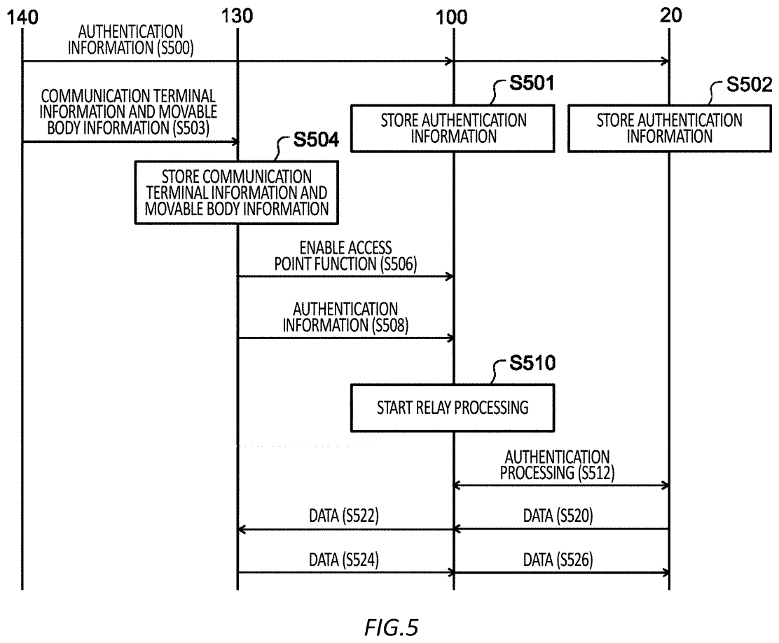

FIG. 5 illustrates an example of a sequence according to a communication control method performed in the communication system 5. With reference to FIG. 5, overall processing performed in the communication system 5 will be described.

In S500, the communication management device 140 outputs authentication information to the communication terminal 100 and the movable body 20 under control of the authentication control unit 430. The authentication information is information for performing mutual authentication between the movable body 20 and the communication terminal 100. The communication management device 140 may transmit the authentication information for the communication terminal 100 to perform authentication of the movable body 20 through the wireless relay device 110. When the movable body 20 is connected to the wireless relay device 110, the communication management device 140 may transmit the authentication information for the movable body 20 to perform authentication of the communication terminal 100. The communication management device 140 may output the authentication information for the movable body 20 to perform the authentication of the communication terminal 100 through other communication means. In S501, the communication terminal 100 stores the authentication information output from the communication management device 140 in the storage unit 280. In S502, the movable body 20 stores the authentication information output from the communication management device 140 in the storage medium included in the movable body 20.

In S503, the communication management device 140 transmits communication terminal information and movable body information to the information management device 130 under control of the authentication control unit 430. The communication terminal information is information for identifying the communication terminal 100. The communication terminal information may be, for example, IMSI, MSISDN, ICCID, IMEI, or the like of the communication terminal 100. The movable body information is information for identifying the movable body. When the movable body is a vehicle as in the present embodiment, the movable body information may be a VIN (vehicle identification number) of the movable body 20. In S504, the information management device 130 stores the communication terminal information and the movable body information which have been received from the communication management device 140 in the storage unit 380.

In S506, the information management device 130 transmits an instruction to enable the wireless LAN access point function included in the communication terminal 100. In S508, the information management device 130 transmits the authentication information to the communication terminal 100. The authentication information may be, for example, information for performing IEEE 802.11u based authentication. The authentication information may be information to be used in communication in accordance with a specification of WBA OpenRoaming. The authentication information may be information to be used in communication in accordance with a specification of Wi-Fi (registered trademark) CERTIFIED Passpoint. The authentication information may include certification information to be used in the authentication.

In S510, the communication terminal 100 starts relay processing of relaying the communication between the movable body 20 and the information management device 130. In S512, the movable body 20 performs authentication processing to establish connection with the nearby communication terminal 100. The authentication processing in S512 is performed by cooperating with the authentication control unit 230 of the communication terminal 100. The authentication processing in S512 may include IEEE 802.11u based authentication processing and mutual authentication processing between the communication terminal 100 and the movable body 20.

When the connection between the movable body 20 and the communication terminal 100 is established, in S520, the movable body 20 transmits data addressed to the information management device 130. The data addressed to the information management device 130 from the movable body 20 may include information indicating a state of the movable body 20 that is being manufactured. The data addressed to the information management device 130 from the movable body 20 may include information generated by an ECU included in the movable body 20, for example. The communication terminal 100 relays and transmits, to the information management device 130, the data addressed to the information management device 130 which has been transmitted from the movable body 20 (S522). For the relay mode, according to a state of communication between the communication terminal 100 and the information management device 130, the relay is performed in the mode selected from among the first mode, the second mode, and the third mode described above.

In S524, the information management device 130 transmits the data addressed to the movable body 20. The communication terminal 100 relays and transmits, to the movable body 20, the data addressed to the movable body 20 which has been transmitted from the information management device 130 (S526). The data addressed to the movable body 20 which has been transmitted from the information management device 130 may include information to be written to the ECU included in the movable body 20 that is being manufactured.

While moving on the production line, the movable body 20 switches a connection destination to the communication terminal 100 with a most satisfactory communication state to perform the communication with the information management device 130. As described above, in an embodiment, since the communication terminal 100 and the movable body 20 adopt the mode in which the communication is performed in accordance with the specification of WBA OpenRoaming, the movable body 20 can communicate with the information management device 130 by establishing the connection with different communication terminals 100 through the common SSID, so that the communication can be seamlessly performed with the information management device 130.

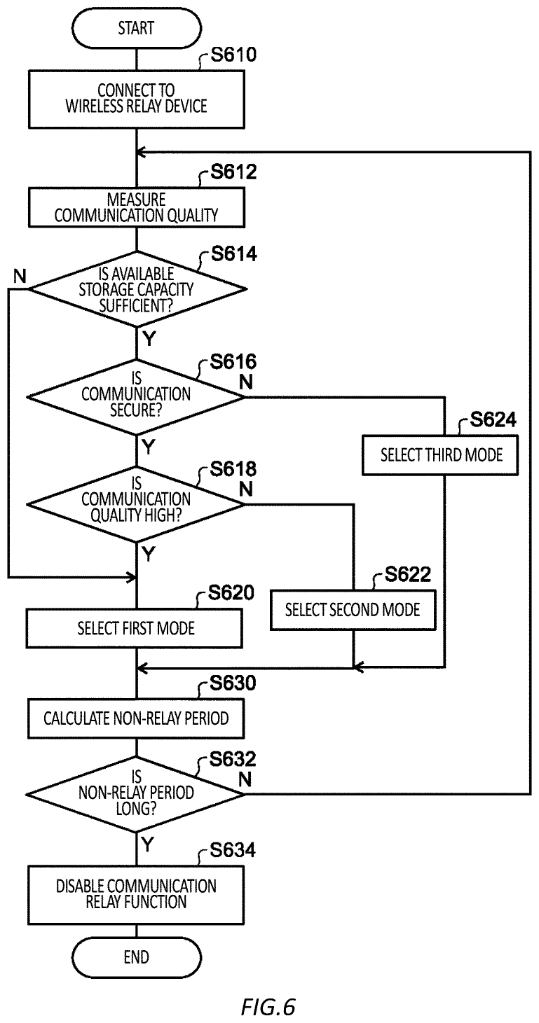

FIG. 6 illustrates an example of a flowchart according to the communication control method performed in the communication terminal 100. In FIG. 6, processing in a case where communication is relayed through the wireless relay device 110 will be exemplified. In S610, the communication terminal 100 connects to the wireless relay device 110. In S612, the control unit 200 of the communication terminal 100 measures a quality of the communication with the information management device 130 via the wireless relay device 110. The quality of the communication measured in S612 may include a quality of a wireless signal between the communication terminal 100 and the wireless relay device 110. The quality of the wireless signal may be, for example, an RSSI (reception signal strength) or the like.

In S614, the control unit 200 of the communication terminal 100 determines whether or not a memory space that can be stored in the storage medium included in the storage unit 280 exceeds a predetermined value. The “memory space that can be stored in the storage medium” may be a memory space of the storage medium included in the storage unit 280 or may be an amount of available space of the storage medium included in the storage unit 280. When the memory space that can be stored in the storage medium included in the storage unit 280 exceeds the predetermined value, the processing is shifted to S616, and when it is determined that the memory space that can be stored in the storage medium included in the storage unit 280 does not exceed the predetermined value, the processing is shifted to S620.

In S616, the control unit 200 determines whether or not the communication between the communication terminal 100 and the information management device 130 is secure. The determination in S616 may include a determination on whether or not a security level of the communication between the communication terminal 100 and the information management device 130 is greater than or equal to a predetermined value. The determination in S616 may include a determination on whether or not the security level of the communication between the communication terminal 100 and the information management device 130 is greater than or equal to a security level required to transmit the data from the movable body 20 to the information management device 130. The security level of the communication between the communication terminal 100 and the information management device 130 may be set depending on a communication channel. For example, a security level in a case where the communication is relayed through the wireless relay device 110 may be set as a value lower than that of the security level in a case where the communication is relayed through the wireless base station 120. The security level required to transmit the data from the movable body 20 to the information management device 130 may be a predetermined value for each type of the data that is to be transmitted. The security level required to transmit the data may be input to the communication terminal 100 by a user such as an operator, or the movable body 20 may notify the communication terminal 100 of the security level. In S616, when it is determined that the communication between the communication terminal 100 and the information management device 130 is secure, the processing is shifted to S618, and when it is determined that the communication between the communication terminal 100 and the information management device 130 is not secure, the processing is shifted to S624.

In S618, the control unit 200 determines whether or not a quality of the communication between the communication terminal 100 and the information management device 130 is greater than or equal to a predetermined value. The quality of the communication may be a value measured in S612. In S618, when it is determined that the quality of the communication between the communication terminal 100 and the information management device 130 is greater than or equal to the predetermined value, the processing is shifted to S620, and when it is determined that the quality of the communication is less than the predetermined value, the processing is shifted to S622. When the communication terminal 100 has selected the first mode as the relay mode in S620 after the relay has been performed in the second mode, the communication control unit 210 may start the relay in the first mode after the data held in the storage medium of the storage unit 280 has been transmitted to the information management device 130.

In S620, the selection unit 240 selects the first mode as the relay mode of the communication between the movable body 20 and the information management device 130. In S622, the selection unit 240 selects the second mode as the relay mode of the communication between the movable body 20 and the information management device 130. In S624, the selection unit 240 selects the third mode as the relay mode of the communication between the movable body 20 and the information management device 130.

In S630, the disabling processing unit 220 calculates a non-relay period that is a period in which the communication terminal 100 does not relay the communication between the movable body 20 and the information management device 130. In S632, the disabling processing unit 220 determines whether or not a duration of the non-relay period is longer than a predetermined value.

When it is determined that the duration of the non-relay period is longer than the predetermined value, in S634, the disabling processing unit 220 disables the relay function of the communication in the communication terminal 100. When it is determined that the duration of the non-relay period is less than or equal to the predetermined value, the processing is shifted to S612.

In connection to FIG. 6, an embodiment mode has been described in which the selection unit 240 performs the processing of selecting the relay mode, but an embodiment mode may be adopted in which the communication management device 140 performs at least part of the processing of selecting the relay mode. In connection to FIG. 6, an embodiment mode has been described in which the disabling processing unit 220 performs the processing of determining whether or not the relay function of the communication in the communication terminal 100 is to be disabled, but an embodiment mode may be adopted in which the disabling processing unit 420 takes an initiative to perform the processing of determining whether or not the relay function is to be disabled. In connection to FIG. 6, an embodiment mode has been described in which the second mode is selected as the relay mode when the quality of the communication is low, but an embodiment mode may be adopted in which the third mode is selected as the relay mode when the quality of the communication is low.

According to the embodiment described above, the movable body 20 is set as a vehicle that is being manufactured but is not limited to this, and the configuration included in the communication system 5 may be applied to communication of any movable body in any state.

In accordance with the communication system 5 described above, the communication terminal 100 can relay the communication between the movable body 20 and the information management device 130 through the communication channel via the wireless relay device 110. Therefore, as compared to a case where the movable body 20 communicates with the information management device 130 through the wireless base station 120, the communication costs can be reduced. In addition to the above, since the mode in which the communication between the movable body 20 and the information management device 130 is relayed is selected according to a state of communication between the communication terminal 100 and the information management device 130, the communication between the movable body 20 and the information management device 130 can be relayed in an appropriate mode according to the state of the communication.

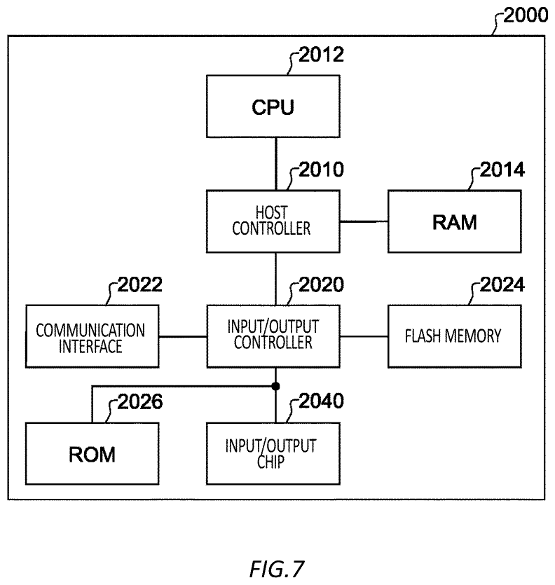

FIG. 7 illustrates an example of a computer 2000 in which a plurality of embodiments of the present invention may be entirely or partially embodied. Programs installed in the computer 2000 can cause the computer 2000 to function as the communication system 5 according to the embodiment or each unit of the system or various devices such as the communication terminal 100, the information management device 130, and the communication management device 140 or each unit of the device, to perform operations associated with the system or each unit of the system or the device or each unit of the device, and/or to perform a process according to the embodiment or a step of the process. Such a program may be executed by a CPU 2012 in order to cause the computer 2000 to execute a specific operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, and thereby controls each unit.

The communication interface 2022 communicates with another electronic device via a network. The flash memory 2024 stores a program and data used by the CPU 2012 in the computer 2000. The ROM 2026 stores a boot program or the like executed by the computer 2000 upon activation, and/or a program which depends on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, and a HDMI (registered trademark) port.

A program is provided via a network or a computer readable storage medium such as a CD-ROM, a DVD-ROM, or a memory card. The RAM 2014, the ROM 2026, or the flash memory 2024 is an example of the computer readable storage medium. The program is installed in the flash memory 2024, the RAM 2014, or the ROM 2026, and executed by the CPU 2012. Information processing written in these programs is read by the computer 2000, and provides cooperation between the programs and the various types of hardware resources described above. A device or a method may be actualized by executing operations or processing of information according to a use of the computer 2000.

For example, when a communication is executed between the computer 2000 and an external device, the CPU 2012 may execute a communication program loaded on the RAM 2014, and instruct the communication interface 2022 to execute communication processing based on processing written in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 and the like to be read into the RAM 2014, and execute various kinds of processing on the data on the RAM 2014. Next, the CPU 2012 writes back the processed data into the recording medium.

Various types of information such as various types of programs, data, a table, and a database may be stored in the recording medium and may be subjected to information processing. The CPU 2012 may execute, on the data read from the RAM 2014, various kinds of processing including various kinds of operations, information processing, conditional judgement, conditional branching, unconditional branching, information retrieval/replacement, or the like described herein and specified by instruction sequences of the programs, and write back a result into the RAM 2014. In addition, the CPU 2012 may retrieve information in a file, a database, or the like in the recording medium. For example, when multiple entries each having an attribute value of a first attribute associated with an attribute value of a second attribute, is stored in the recording medium, the CPU 2012 may retrieve an entry having a designated attribute value of the first attribute that matches a condition from these multiple entries, and read the attribute value of the second attribute stored in this entry, thereby obtaining the attribute value of the second attribute associated with the first attribute that satisfies a predetermined condition.

The program or software module described above may be stored in a computer readable storage medium on the computer 2000 or near the computer 2000. A recording medium such as a hard disk or a RAM provided in a server system connected to a dedicated communication network or the Internet can be used as the computer readable storage medium. A program stored in the computer readable storage medium may be provided to the computer 2000 via a network.

When programs which are installed in the computer 2000 and cause the computer 2000 to function as the communication terminal 100 are performed by the computer, the computer 2000 may be caused to function as each unit of the communication terminal 100 by working with the CPU 2012 or the like. When information processing described in these programs are read by the computer 2000, the computer 2000 functions as each unit of the communication terminal 100 that is specific means in which software and various hardware resources described above cooperate with each other. These specific means implement operations or processing of information according to the intended use of the computer 2000 in the present embodiment, and the communication terminal 100 is thereby constructed to be specific for the intended use.

When programs which are installed in the computer 2000 and cause the computer 2000 to function as the information management device 130 are performed by the computer, the computer 2000 may be caused to function as each unit of the information management device 130 by working with the CPU 2012 or the like. When information processing described in these programs are read by the computer 2000, the computer 2000 functions as each unit of the information management device 130 that is specific means in which software and various hardware resources described above cooperate with each other. With these specific means, the specific information management device 130 according to an intended use can be configured by realizing the calculations or computations of the information according to the intended use of the computer 2000 of the present embodiment.

When programs which are installed in the computer 2000 and cause the computer 2000 to function as the communication management device 140 are performed by the computer, the computer 2000 may be caused to function as each unit of the communication management device 140 by working with the CPU 2012 or the like. When information processing described in these programs are read by the computer 2000, the computer 2000 functions as each unit of the communication management device 140 that is specific means in which software and various hardware resources described above cooperate with each other. With these specific means, the specific communication management device 140 according to an intended use can be configured by realizing the calculations or computations of the information according to the intended use of the computer 2000 of the present embodiment.

Various embodiments have been described with reference to the block diagrams and the like. In the block diagrams, each block may represent (1) a stage of a process in which an operation is executed, or (2) each unit of the device having a role in executing the operation. A specific step and each unit may be implemented by a dedicated circuit, a programmable circuit supplied with computer readable instructions stored on a computer readable storage medium, and/or a processor supplied with computer readable instructions stored on a computer readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element or the like such as a flip-flop, a register, a field programmable gate array (FPGA), a programmable logic array (PLA), or the like.

The computer readable storage medium may include any tangible device capable of storing instructions to be executed by an appropriate device. Thereby, the computer readable storage medium having instructions stored therein forms at least a part of a product including instructions which can be executed to provide means for executing processing procedures or operations specified in the block diagrams. An example of the computer readable storage medium may include an electronic storage medium, a magnetic storage medium, an optical storage medium, an electromagnetic storage medium, a semiconductor storage medium, etc. A more specific example of the computer readable storage medium may include a FLOPPY (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disk read-only memory (CD-ROM), a digital versatile disk (DVD), a Blu-ray (registered trademark) disk, a memory stick, an integrated circuit card, or the like.

The computer readable instructions may include an assembler instruction, an instruction-set-architecture (ISA) instruction, a machine instruction, a machine-dependent instruction, a microcode, a firmware instruction, state-setting data, or either of source code or object code written in any combination of one or more programming languages including an object-oriented programming language such as Smalltalk (registered trademark), JAVA (registered trademark), and C++, or the like, and a conventional procedural programming language such as a “C” programming language or a similar programming language.

The computer readable instruction are provided to a processor of a programmable data processing device such as a computer or programmable circuit locally or via a local area network (LAN) or a wide area network (WAN) such as the Internet, and the computer readable instruction may be performed to bring about means to perform the operations specified in the processing procedures or block diagrams which have been described.

Here, the computer may be a computer such as a personal computer (PC), a tablet computer, smartphone, a work station, a server computer, or a general purpose computer, or may be a computer system in which a plurality of computers are connected. Such computer system to which the plurality of computers are connected is also referred to as a distributed computing system, and is a computer in a broad sense. In the distributed computing system, a plurality of computers collectively execute a program by each of the plurality of computers executing a portion of the program, and passing data during the execution of the program among the computers as needed.

Examples of the processor include a computer processor, a central processing unit (CPU), a processing unit, a microprocessor, a digital signal processor, a controller, a microcontroller, and the like. The computer may include one processor or a plurality of processors. In a multi-processor system including a plurality of processors, the plurality of processors collectively execute a program by each of the processors executing a portion of the program, and passing data during the execution of the program among the processors as needed. For example, in execution of multiple tasks, each of the plurality of processors may execute a portion of each task pieces by pieces by performing task-switching for each time slice. In this case, which portion of one program each processor is responsible for executing dynamically changes. In addition, which portion of the program each of the plurality of processors is to execute may be statically determined by multi-processor aware programming.

While the present invention has been described by way of the embodiments above, the technical scope of the present invention is not limited to the above-described embodiments. It is apparent to persons skilled in the art that various alterations or improvements can be made to the above-described embodiments. It is also apparent from description of the claims that the embodiments to which such modifications or improvements are made may be included in the technical scope of the present invention.

It should be noted that each process of the operations, procedures, steps, stages, and the like performed by the device, system, program, and method shown in the claims, specification, or drawings can be executed in any order as long as the order is not indicated by “prior to”, “before”, or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

5: communication system;
20: movable body;
90 communication network;
92: cellular communication network;
100: communication terminal;
110: wireless relay device;
120: wireless base station;
130: information management device;
140: communication management device;
200: control unit;
210: communication control unit;
220: disabling processing unit;
230: authentication control unit;
240: selection unit;
280: storage unit;
290: communication unit;
300: control unit;
310: communication control unit;
320: disabling processing unit;
380: storage unit;
390: communication unit;
400: control unit;
410: communication control unit;
420: disabling processing unit;
430: authentication control unit;
440: selection unit;
480: storage unit;
490: communication unit;
2000: computer;
2010: host controller;
2012: CPU;
2014: RAM;
2020: input/output controller;
2022: communication interface;
2024: flash memory;
2026: ROM; and
2040: input/output chip.

What is claimed is:

1. A communication control system which controls communication in a communication terminal which relays communication between a movable body and an information management device, the communication control system comprising:
a selection unit which selects, according to a state of communication between the communication terminal and the information management device, a relay mode in which the communication terminal relays the communication between the movable body and the information management device.

2. The communication control system according to claim 1, wherein
the relay mode includes at least one of
a first mode in which data to be communicated between the movable body and the information management device is transferred from one to another,
a second mode in which data to be communicated between the movable body and the information management device is temporarily held in a storage medium included in the communication terminal, and transfer of the data temporarily held in the storage medium is started according to the state of the communication between the communication terminal and the information management device, and also relay of the communication between the movable body and the information management device is resumed, or
a third mode in which data to be communicated between the movable body and the information management device is held in the storage medium, and transfer of the data held in the storage medium is started in response to acceptance of a data transfer instruction.

3. The communication control system according to claim 1, wherein
the selection unit selects the relay mode further based on a state of a storage medium included in the communication terminal.

4. The communication control system according to claim 1, wherein
when at least one of a capacity of a storage medium included in the communication terminal or an amount of available space of the storage medium is less than or equal to a predetermined value, the selection unit selects a first mode in which data to be communicated between the movable body and the information management device is transferred from one to another.

5. The communication control system according to claim 1, wherein
the selection unit selects the relay mode based on a state of communication between the communication terminal and a wireless relay device which relays the communication between the communication terminal and the information management device.

6. The communication control system according to claim 5, wherein
when a quality of the communication between the wireless relay device and the communication terminal is greater than or equal to a predetermined value, the selection unit selects a first mode in which data to be communicated between the movable body and the information management device is transferred from one to another.

7. The communication control system according to claim 5, wherein
when a quality of the communication between the wireless relay device and the communication terminal is less than a predetermined value, the selection unit selects a second mode in which data to be communicated between the movable body and the information management device is temporarily held in a storage medium included in the communication terminal, and transfer of the data temporarily held in the storage medium is started according to the state of the communication between the communication terminal and the information management device, and also relay of the communication between the movable body and the information management device is resumed.

8. The communication control system according to claim 6, wherein
when the quality of the communication between the wireless relay device and the communication terminal is less than the predetermined value, the selection unit selects a second mode in which data to be communicated between the movable body and the information management device is temporarily held in a storage medium included in the communication terminal, and transfer of the data temporarily held in the storage medium is started according to the state of the communication between the communication terminal and the information management device, and also relay of the communication between the movable body and the information management device is resumed.

9. The communication control system according to claim 1, wherein
the selection unit selects, according to a security level of the communication between the communication terminal and the information management device, the relay mode in which the communication terminal relays the communication between the movable body and the information management device.

10. The communication control system according to claim 9, wherein
when the security level is less than or equal to a predetermined value, the selection unit selects a third mode in which data to be communicated between the movable body and the information management device is held in a storage medium included in the communication terminal, and transfer of the data held in the storage medium is started in response to acceptance of a data transfer instruction.

11. The communication control system according to claim 1, further comprising:
a communication control unit which causes, when the communication terminal can communicate with the information management device based on cellular communication and wireless LAN communication, the communication terminal to communicate with the information management device based on the wireless LAN communication by priority over the cellular communication.

12. The communication control system according to claim 1, wherein
the communication control system controls communication in a plurality of communication terminals which relay the communication between the movable body and the information management device,
the plurality of communication terminals and the movable body are capable of establishing wireless LAN connection through a single SSID, and
the communication control system further comprises:
a communication control unit which sets an SSID common to the plurality of communication terminals to enable the movable body to establish wireless LAN connection with the plurality of communication terminals through the single SSID.

13. The communication control system according to claim 1, further comprising:
an authentication control unit which performs authentication between the movable body and the communication terminal by 802.11u based authentication and mutual authentication between the movable body and the communication terminal.

14. The communication control system according to claim 1, further comprising
a disabling processing unit which disables a function of the communication terminal to relay the communication between the movable body and the information management device when a duration of a period in which the communication terminal does not relay the communication between the movable body and the information management device is longer than a predetermined value.

15. The communication control system according to claim 1, further comprising
a communication control unit which restricts, when the communication terminal can communicate with the information management device based on cellular communication, the communication between the communication terminal and the information management device based on the cellular communication.

16. The communication control system according to claim 2, wherein
the selection unit selects the relay mode further based on a state of the storage medium included in the communication terminal.

17. The communication control system according to claim 2, wherein
when at least one of a capacity of the storage medium included in the communication terminal or an amount of available space of the storage medium is less than or equal to a predetermined value, the selection unit selects the first mode in which the data to be communicated between the movable body and the information management device is transferred from one to another.

18. The communication control system according to claim 2, wherein
the selection unit selects the relay mode based on a state of communication between the communication terminal and a wireless relay device which relay the communication between the communication terminal and the information management device.

19. A communication control method of controlling communication by a communication terminal which relays communication between a movable body and an information management device, the communication control method comprising:
selecting, according to a state of communication between the communication terminal and the information management device, a relay mode in which the communication terminal relays the communication between the movable body and the information management device.

20. A non-transitory computer readable storage medium having stored thereon a program for controlling communication in a communication terminal which relays communication between a movable body and an information management device, the program causing a computer to function as:
a selection unit which selects, according to a state of communication between the communication terminal and the information management device, a relay mode in which the communication terminal relays the communication between the movable body and the information management device.
